(19) United States
(12) Patent Application Publication
(10) Pub. No.: US 2007/0138749 A1
(43) Pub. Date: Jun. 21, 2007

(54) Seal for a stuffing box of a gland

(76) Inventor: Michael Pattemore, Surrey (GB)

Correspondence Address: BLANK ROME LLP, 600 NEW HAMPSHIRE AVENUE, N.W., WASHINGTON, DC, 20037, US

(21) Appl. No.: 10/586,619

(22) PCT Filed: Jan. 19, 2005
(86) PCT No.: PCT/GB05/00141

§ 371 Date: Jan. 29, 2007

(30) Foreign Application Priority Data
Jan. 19, 2004 (GB) 0401019.5

(51) Int. Cl. F16J 15/18

(52) U.S. Cl. 277/511

(57) ABSTRACT

A seal for inter alia a stuffing box of a gland, the seal having an aperture through which lubricant can pass and at least one track detachably secured to at least one surface of the seal.

The present invention relates to a seal. More specifically, but not exclusively, the invention relates to a seal for a stuffing box of a gland.

A gland generally comprises a stuffing box through which a shaft passes. The stuffing box has packings within it which bear on the shaft. The packings have a gland follower which acts on the packings to force them into an appropriate sealing position. Gland packings are generally supplied in lengths of material impregnated with a suitable lubricant. To install a packing, a workman will first have cut the packing material to a required length and then force the packing into the stuffing box and around the shaft so that the packing forms the shape of a ring around the shaft. This process if repeated for each packing required.

The process for installing and replacing gland packings is extremely cumbersome and dirty, particularly as the lubricant of the packings is often oil based. Moreover, the down-time for the pump requiring its glands to be re-packed tends often to be considerable.

Furthermore, workmen often only estimate the amount of packing material needed to form an efficient packing and, consequently, a considerable wastage of material, which is often expensive, occurs.

Conventional gland packings tend to be impregnated with lubricant throughout their entire cross-section. However, lubricant is only required in the proximity of the shaft. The remaining lubricant is therefore unused. As such, the useful time of the packing is determined by the amount of lubricant around the shaft.

The applicant's earlier UK Patent No. 1170583 relates to a seal to replace conventional gland packing. The seat comprises a resiliently deformable hollow ring containing lubricant and having openings passing through the inner portions thereof through which the lubricant can flow. The surface of the ring is covered by a material suitable for the application of the gland. Such materials include PTFE, aramid fibre, or carbon fibre.

While the seal disclosed in the aforementioned patent has proven to be very successful in the market for glands of the majority of applications the cost of the cover material substantially increases the overall cost of manufacture of the seal.

According to one aspect of the present invention, there is provided a seal having at least one aperture through which lubricant can pass and at least one track detachably secured to, and extending along, at least part of the length of at least one surface of the seal.

Preferably the seal takes the form of at least one hollow annular ring.

Preferably the seal is made from an elastomeric material. Advantageously the seal is made from a formulated elastomeric compound having resilience such as rubber-like.

Preferably, the seal is formed as an elongated elastomeric extrusion.

Preferably the track or each is interchangeable with a further track of the same design.

Preferably the or each track has a material strip attached thereto. Preferably still the material strip is formed from fibrous material. Advantageously, the material strip is porous.

In a preferred embodiment the seal has at least one aperture enabling the lubricant to flow to the track surface. Preferably still, the track has at least one aperture enabling the lubricant to flow to and into the material strip.

In a preferred embodiment, the seal has a further aperture allowing lubricant to pass to neighbouring seals via a connection means. Preferably, the connection means takes the form of a hollow tube.

According to a second aspect of the present invention there is provided, a seal comprising a chamber for containing lubricant, the chamber having a path to allow flow of lubricant to an outer surface of the seal so to cool that surface, and the seal having at least one track detachably secured to, and extending along, the length of at least one surface the seal.

Preferably, the chamber comprises at least one longitudinal groove formed in the outer surface of the seal.

According to a third aspect of the present invention there is provided, a seal adapted to contain a lubricant whose external surface is in part defined by a lengthwise extending track releasably secured to the remaining part or parts of the seal external surface.

According to a fourth aspect of the present invention there is provided, a method of producing a seal adapted to contain a lubricant, the method comprising the steps of:

extruding a strip having a lubricant containing channel bordered on all but one surface by a cover formed Integrally with the strip,

extruding an elongate track dimensioned to fit said one surface, and

detachably securing the track to the strip.

The invention will now be described by way of example with reference to the accompanying diagrammatic drawings, in which:

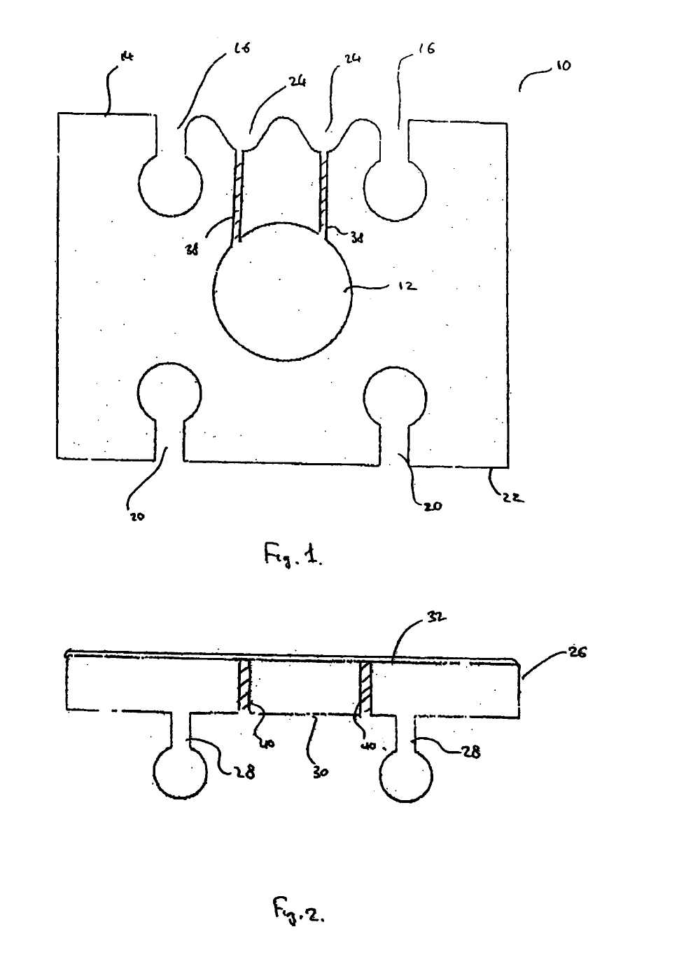

FIG. 1 is a section view of a seal constructed in accordance with the present invention with the track removed;

FIG. 2 is a section view of a track of the seal of FIG. 1;

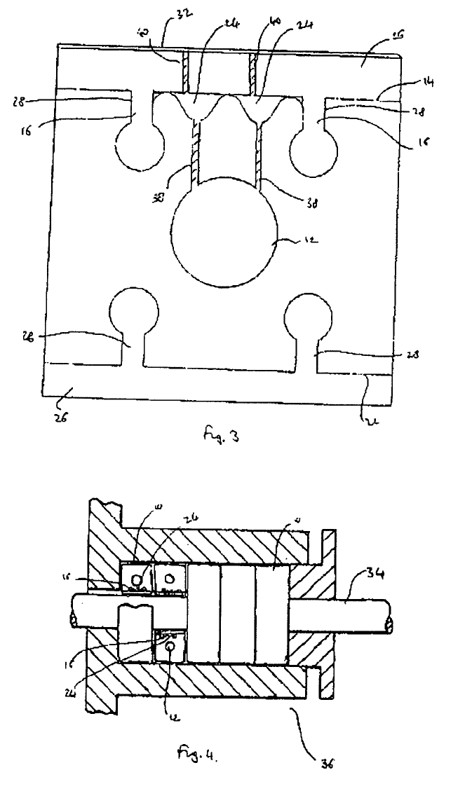

FIG. 3 is a section view of the seal of FIG. 1 with the track of FIG. 2 attached thereto; and

FIG. 4 is a section view through a stuffing box incorporating seals of FIG. 3.

Referring first to FIG. 1, a seal 10 constructed in accordance with the present invention is made from an elastomeric material such as silicone rubber, viton or the like. The seal 10 is preferably formed as an elongated elastomeric extrusion. The seal 10 is generally rectangular in cross-section and has an inner channel 12 running through its middle and extending along the length of the extrusion 10. The channel 12 is shown in FIG. 1 to be of circular cross-section but can be of any profile, for example, oval or square. Alternatively their may be a plurality of internal channels.

One surface 14 of the seal 10 has two primary longitudinal channels 16 spaced from and located parallel to one another. Each channel 16 is bulbar. Similar longitudinal bulbar channels 20 are formed in the opposite surface 22 of the seal 10. Two further secondary longitudinal channels 24 are formed in the surface 14 of the seal 10 between the primary channels 16. The secondary channels 24 have a depth of less than the primary channels 16, preferably a depth of approximately one half of the primary channels 16.

FIG. 2 shows a track 26 for attaching to the surfaces 14, 22 of the seal 10. The track 26 is also formed as an elastomeric extrusion such that, when a track 26 is attached to either or both surfaces 14, 22 of the seal 10 it replaces, and acts as, that surface 14, 22 of the seal 10. Each track has two longitudinal bulbar ridges 28 protruding outwardly from its bottom surface 30. The ridges 28 are shaped to correspond to the shape of the channels 16, 20 and are resilient such that the track 26 can be simply attached to the surface 14, 22 of the seal 10 by pushing the track 26 down onto the surface 14, 22 and can simply be removed by puling the track 26 away from the surface.

Although the description refers to the primary channels 16, 20 and ridges 28 as being bulbar, it is clearly envisages that they could be of re-entrant shape, for example, T-shaped or key-shaped provided that they correspond to allow easy attachment and detachment of the track 26 to and from the seal 10.

The channels 16, 20 and track 26 may be described as having male and female engagement means.

In a further embodiment (not shown) the seal may have a side which is formed with male engagement means and the opposite side formed with female engagement means. In such a construction, two seals can be attached to each other by interconnecting the male engagement means of one seal with the female engagement means of the other seal. A plurality of seals can be attached together in this way forming a chain.

In a further alternative embodiment a side of the seal may have a combination of male and female engagement means.

The track 26 is generally formed as a thin strip which does not substantially increase the over dimensions of the seal 10 when attached. However, it is clearly envisaged that the track 26 could be made to any pre-determined thickness such that its attachment will increase the overall dimensions of the seal 10 by a pre-calculated amount.

Although in the embodiment described, the seal 10 is designed to allow attachment of a track 26 to two of its opposing sides 14, 22, it is clear that the other two opposing surfaces of the seal 10 may also have longitudinal primary channels formed therein to allow tracks 26 to be located on all four surfaces of the seal 10. Alternatively, only a single surface 14 of the seal 10, may be formed to accept a track 26.

In a further embodiment (not shown), the tracks have primary channels formed on a top surface 30 to allow engagement with a further track 26. This allows any number of tracks 26 to be attached on top of one another to increase the size of the overall seal 10 if required.

The top surface 30 of each track 26 has a strip of fibrous material 32 adhered thereto. Alternatively, the strip of fibrous material 32 may be braided or sewn onto the top surface 30 of the track 26. The material of the strip 32 depends on the application of the gland in which the seal 10 is to be incorporated. For example, for acid application the strip 32 may be made of Polytetrafluoroethylene (PTFE). Other materials of the strip include, but not exclusively, cotton, flax, asbestos (pure or commercial grade), aramid fibre, graphite fibre, or similar natural synthetic material arranged into a porous form preferably by braiding or weaving, such that the lubricant can flow therethrough. The material may also have a covering of mica flakes, graphite molybdenum disulphide or the like.

In an alternative arrangement the track 26 itself may be extruded from a desired material such as, for example, Teflon™. In such an arrangement a strip 32 may not be required as the material of the track 26 itself provides a surface having the desired properties and characteristics for the application to which the seal is to be used.

As the tracks 26 are easily replaceable and interchangeable, the same seal 10 can be used for any gland application, the only change required being that of the track 26 which needs to have a strip 32 suitable for that application.

Referring now to FIG. 4, the seal extrusion 10 is cut into suitable lengths which are worked in such a way to form a generally circular ring. Thereafter the ring is wound about a former mandrel so that it takes up the appropriate diameter and is cured in this position.

The extruded ring material is then cut to have two ends. The channel 12 of the seal 10 is then filled with a lubricant (not shown) of fairly high viscosity. A short rigid elastomeric tube (not shown) which is interference-fitted into the end of the seal 10 so that a complete ring is thus formed.

Apertures 38 are drilled or punched radially through the secondary channels 24 through the seal into the channel 12 containing the lubricant. Apertures 40 are also drilled or punched radially through the track 26. The lubricant is thus permitted to flow from the channel 12 into the secondary channels 24 and, from there, into the fibrous material strip 32 located on the track 26. In other words, during use, the lubricant will flow in a direction towards the shaft 34 of the stuffing box 36 to cool the shaft 34, particularly at pump start-up and when the shaft 34 is rotating at high speed.

All the apertures are equispaced from one another. Preferably there are approximately six to eight apertures depending on the on the diameter of the seal ring 10. The secondary channels 24 allow for a small quantity of lubricant to allows be retained directly underneath the track 26 to cool the track 26 during use.

Although it is possible to have a suitable track 26 attached to any or each surface of the seal 10, in the majority of cases, the only surface of the seal 10 that requires protection through the fibrous strip 32 cover is the surface which engages with the shaft 34 of the stuffing box 36 of the gland (see FIG. 4). Consequently, in most cases only one track 26 is required to be changed when either the application of the gland changes, or the track 26 the needs replacing due to wearing of the strip 32.

To insert the seals 10 into the stuffing box 36 which has been previously cleaned out, a workman must firstly attach a track 26 having a suitable fibrous material strip 32 to the appropriate surfaces of the seal 10. Thereafter the workman simply needs to open the seal ring 10 out by pulling the ends connected by the rigid tube apart and place the seal 10 over and around the shaft 34 of the stuffing box 36 and fit the ends of the seal 10 back together. The workman must ensure that the track 26 having the material strip 32 is adjacent to the shaft 34.

In a further embodiment (not shown) each seal ring 12 has at least one lateral aperture extending from the channel 12 to the outer surface of the seal 10 thereby to allow connection, via a tube for example, between neighbouring seals 10 to allow flow of lubricant therebetween.

The overall seal system may comprise a singular endless spiral rather than a plurality of individual seal rings 10.

The above described embodiments have been given by way of example only, and the skilled reader will naturally appreciate that many variations could be made thereto without departing from the scope of the present invention.

1. A seal having at least one aperture through which lubricant can pass and at least one track detachably secured to, and extending along, at least part of the length of at least one surface of the seal.

2. A seal according to claim 1, wherein the seal takes the form of at least one hollow annular ring.

3. A seal according to claim 1, wherein the seal is made from an elastomeric material.

4. A seal according to claim 3, wherein the seal is made from a formulated elastomeric compound having resilience such as rubber-like.

5. A seal according to claim 3, wherein the seal is formed as an elongated elastomeric extrusion.

6. A seal according to claim 1, wherein the track or each is interchangeable with a further track of the same design.

7. A seal according to claim 1, wherein the or each track has a material strip attached thereto.

8. A seal according to claim 7, wherein the material strip is formed from fibrous material.

9. A seal according to claim 8, wherein the material strip is porous.

10. A seal according to claim 1, wherein the seal has at least one aperture enabling the lubricant to flow to the track surface.

11. A seal according to claim 10, wherein the track has at least one aperture enabling the lubricant to flow to and into the material strip.

12. A seal according to claim 10, wherein the seal has a further aperture allowing lubricant to pass to neighbouring seals via a connection means.

13. A seal according to claim 12, wherein the connection means takes the form of a hollow tube.

14. A seal comprising a chamber for containing lubricant, the chamber having a path to allow flow of lubricant to an outer surface of the seal so to cool that surface, and the seal having at least one track detachably secured to, and extending along, the length of at least one surface the seal.

15. A seal according to claim 14, wherein the chamber comprises at least one longitudinal groove formed in the outer surface of the seal.

16. A seal adapted to contain a lubricant whose external surface is in part defined by a lengthwise extending track releasably secured to the remaining part or parts of the seal external surface.

17. A method of producing a seal adapted to contain a lubricant, the method comprising the steps of:
extruding a strip having a lubricant containing channel bordered on all but one surface by a cover formed integrally with the strip,
extruding an elongate track dimensioned to fit said one surface, and
detachably securing the track to the strip.

18. A seal substantially as hereinbefore described as referred to in the accompanying drawings.

19. A method substantially as hereinbefore described as referred to in the accompanying drawings.
